(19) United States
(12) Patent Application Publication
(10) Pub. No.: US 2007/0224699 A1
(43) Pub. Date: Sep. 27, 2007

(54) X-ray visualizer, laser-beam operated micro-dissector, automated tissue processor

(76) Inventor: Jackson L. Gates, Conyers, GA (US)

Correspondence Address: JACKSON LAVALE GATES, MD, 1880 LANCASTER DRIVE, CONYERS, GA, 30013, US

(21) Appl. No.: 11/340,162

(22) Filed: Mar. 23, 2006

(51) Int. Cl. G01N 1/00

(52) U.S. Cl. 436/174

(57) ABSTRACT

This invention employs the X-ray examination of tissue rather than gross examination from the human naked eye, which may be less exact than the more fine detailed analysis that may be gained through an X-ray system. Selection of more precise tissue sampling for microscopy without exhausting small biopsies can be made through computer operated laser-microtome. This selected tissue slicing/sampling may then be subjected through the various tissue processing methodologies commonly employed to include convention as well as microwave techniques. The processed tissue placed on a special microchip, is then appropriately transferred to a slide for Hematoxylin and Eosin (H- and E) staining, or special staining procedures, i.e. immuno-stains or special histiochemical stains. The prepared stained slide, thoroughly put through a fully automated mechanical apparatus is then covered slip, allowed to dry, and is ready for microscopic viewing by a pathologist. The pathologist receives, alone with the prepared slide, a copy of the X-ray analysis/dimension of the tissue biopsy. This process takes less than one (1) hour from start to finish, giving the pathologist a chance to render a final pathology report less than 24 hours after receipt of the biopsy specimen in the histopathology laboratory. This type of system would markedly reduced safety risks from biohazard material, and would be perceived as environmentally friendly because of it being a closed system with ventilation through exterior exhaust.

### CROSS REFERENCE TO RELATED APPLICATION

This is my first and only patent invention application.

This invention is a modification of commonly established tissue processing methodologies in the setting of histopathology medical laboratory practice. By integrating x-ray technology with routine procedures common to the anatomic pathology lab, it is designed to improve workflow by reducing workload and improving turnaround time in a busy medical laboratory practice. A busy medical laboratory practice is defined as one processing at least one hundred biopsy specimens per day.

Its components include: an x-ray apparatus, a modified laser-beam operated microtome (cutting apparatus), automated tissue processor, automated slide preparer, automated stainer, automated cover-slipper, heater or dryer, and an embedded computer data analogue all connected by mechanical chains and belts to move items from on station to the next. Accessory parts include: specially designed micro-cassettes for holding tissue in place during x-ray and tissue cutting; and a microchip which the cut-tissue is placed on for tissue processing then transferred to a bar-coded glass slide for routine or special staining or to be held unstained for future studies (i.e. immunohistiochemistry or molecular). The microchips designed to collect thinly sliced tissue would have tiny holes that allow the various solutions for tissue processing to penetrate the cut-biopsy sample while keeping the tissue in place. Each laser-microtome section would be automatically set up for at least two to three thinly sliced (4-5 microns) sections depending on the size and complexity of the tissue biopsy sample as determined after analysis through the initial x-ray step. The computer is used to integrate the system functions, and to sequence tissue preparation from the initial x-ray phase to the completion of the prepared slide for the pathologist to review.

Models of this system would include: (1) a version for conventional processing methodology (CPM); and (2) a version for continuous-specimen-flow-high through-put processor methodology (CTMP) [refer to U.S. Pat. No. 6,207,408].

All systems would include an exhaust apparatus to be connected to an external exhaust and/or ventilation system.

Most tissue biopsy samples would be acceptable for this type of processing. However, modifications of procedures may be necessary for bone and/or firm tissue. The tissue would be immediately processed from specimen container to processor without the need for gross examination. Details about the number of fragments of tissue, tissue size in dimensions, or other features would be gathered from the x-ray analysis, and stored into a computer data system to be given to the pathologist along with the prepared slide at the time of pathological microscopic review.

### STATEMENT REGARDING FEDERALLY SPONSORED OR DEVELOPMENT

I Jackson L. Gates, reserve complete and full rights and authorship to the above mentioned invention, and am under no restriction or obligation from federally sponsored research or development.

### REFERENCE TO SEQUENCING LISTING, A TABLE, OR A COMPUTER PROGRAM LISTING COMPACT DISC APPENDIX

None specifically determined at this time.

### BACKGROUND OF THE INVENTION

As mentioned above in the specification section

### SELECTED REFERENCES

1. Morales, A R, et.al. Archives of Pathology and Laboratory Medicine: Vol. 126, No. 5, pp. 583-590.
2. Gal, Anthony. Archives of Pathology and Laboratory Medicine: Vol. 129, No. 12, pp. 1532-1535
3. Swanbrow, Diane. Looking at medical technology through the history of the x-ray: 100 Years of a Piercing Glance. Michigan Today. 1995.
4. Computer from Wikipedia, the free encyclopedia (online)

### BRIEF SUMMARY OF INVENTION

Commonly employed tissue processing technique and staining methodologies require many hours to completion delaying final pathology report by at least twenty four hours. Patients and their physicians are anxiously waiting to receive the final pathology report so that they may have a peace of mind, and so that treatment options may be initiated if necessary. The only procedure known today that would be faster than this invention would be a frozen-section preparation, which takes generally less than fifteen (15) minutes to complete.

Cost-cutting efforts have constrained today's laboratories to becoming trimmed, doing more with less personnel, and thus, reducing workload to operate at greater proficiency and efficiency.

Safety is also extremely important. In that, efforts should always be made to limit workers exposure to biohazard material.

In the current invention, these issues are resolved. The average time to complete the work volume utilizing this invention would be in the order of less than one (1) hour, from start to finish. Workers' limited exposure to biohazard material is also assured

### BRIEF DESCRIPTION OF DRAWINGS

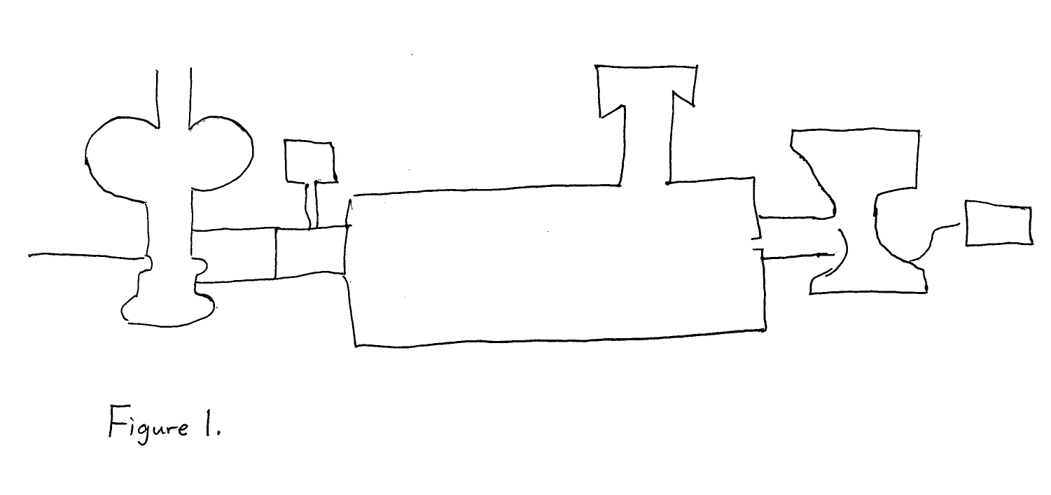

The invention known as the X-ray, Visualizer, Micro-dissector, Automated tissue processor is composed of a simple, straight tube X-ray apparatus, connected to a power light source, and photo analyzer which is connected to the housing system for the laser microtome. The microtome housing is attached to the tissue processor (convention or microwave), automated stainer, automated cover slipper, heater/dryer, and computer analogue with printer attached. A mechanical stage with chains and belts move the tissue or slide through various stages of the enclosed instrument/apparatus, with an exhaust vent to the exterior ventilation system. The tissue or biopsy specimen is initially placed on a loading belt then moved through the various apparatuses. (Refer to FIG. 1.)

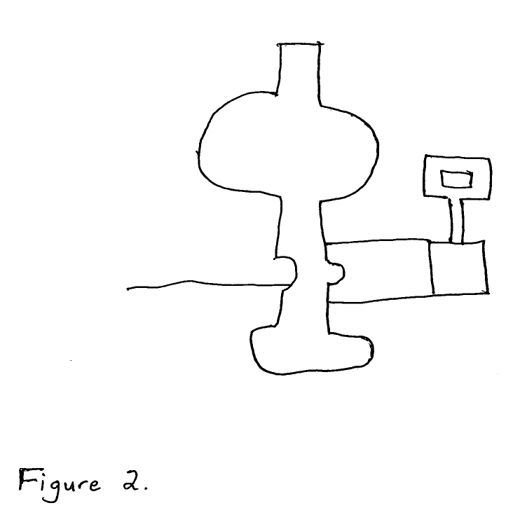

The X-ray apparatus is a simple tube that has an examining stage on which the tissue is received via the loading belt through a small aperture with automated door. The light source and power supply are operated via a computer analogue system. An X-ray image is portrayed on a viewing screen above the photo analyzer box. Measurements of the tissue are taken in three dimensions, as well as level of complexity of the tissue density. The optimal microtome sectioning is determined via X-ray analysis, and integrated into the laser-microtome memory. (Refer to FIG. 2.)

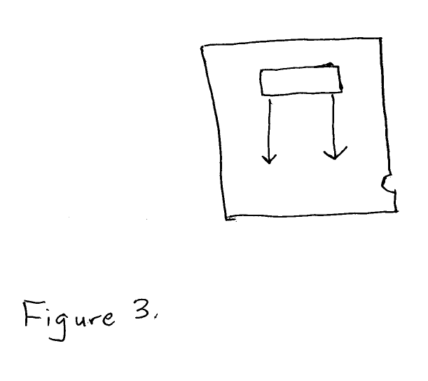

The Laser-microtome housing unit consists of a microtome with special knife-cutting apparatus. After the tissue is sectioned, the sectioned tissue is placed on a special microchip to be transferred to the tissue processor, and the remaining tissue is collected in a special cassette, for permanent storage. (Refer to FIG. 3)

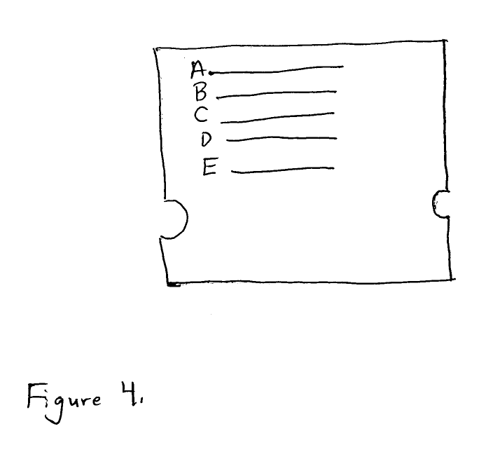

The tissue processor would include two models. One model would be designed for conventional processing (CPM), and the second model would be designed for microwave technique (CTPM). The tissue processor (conventional) consists of various wells containing solutions labeled (A) through (G) for example. The tissue placed on the special microchip is incubated in each well for a specific time, the transmitted to other stations via a mechanical arm (chain or belt) until completion of the tissue processing. The processed tissue on the special microchip is transferred to a slide and placed on a slide rack for storage until slide is ready to be stained with either H- and E, or special stains. (Refer to FIG. 4).

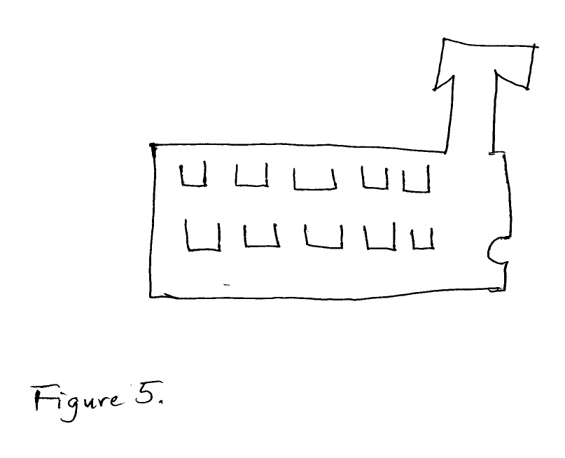

The automated stainer consists of various wells containing various dyes which make up the routine Hematoxylin and Eosin stain (H- and E) or the special stain. The prepared slide is transmitted via a mechanical arm (belt or chain) through the various solutions (e.g. solutions A-G) at appropriate intervals of incubation. (Refer to FIG. 5)

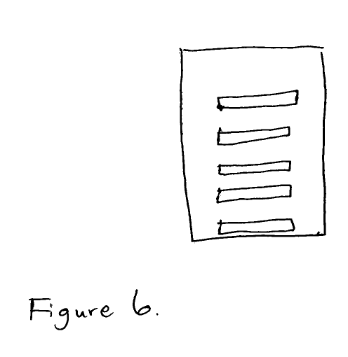

The stained slide is cover-slipped automatically, placed in a heater for a certain amount of time to allow drying then given to the pathologist for review with appropriately bar-coded label. (Refer to FIG. 6)

### DETAILED DESCRIPTION OF THE INVENTION

As described in the specification section above.

1. I, Jackson L. Gates, acclaim to complete authentication of this invention, combining X-ray imaging to determine gross dimensions of tissue, to determine the level of microscopic sectioning of tissue integrated by a computer analogue-guided laser microtome with commonly employed tissue processing methodologies within an enclosed, fully automated mechanical apparatus.
